(19) United States
(12) Patent Application Publication
(10) Pub. No.: US 2026/0237979 A1
(43) Pub. Date: Aug. 13, 2026

(54) CABINET AND SUBSTATION FOR PHOTOVOLTAIC POWER GENERATION

(71) Applicant: Sungrow Power Supply Co., Ltd., Hefei (CN)

(72) Inventors: Hanfei Pan, Hefei (CN); Xianwei Zhang, Hefei (CN); Xiaohu Wang, Hefei (CN)

(73) Assignee: Sungrow Power Supply Co., Ltd., Hefei (CN)

(21) Appl. No.: 19/154,729

(22) PCT Filed: Jun. 6, 2023
(86) PCT No.: PCT/CN2023/098538

§ 371 Date: Aug. 7, 2025

(30) Foreign Application Priority Data
Feb. 8, 2023 (CN) 202320249612.9

(51) Int. Cl. H02B 1/32; H02B 1/56

(52) U.S. Cl. CPC H02B 1/32; H02B 1/565

(57) ABSTRACT

A cabinet and a substation for photovoltaic power generation are provided. The cabinet includes a cabinet body and branch switches arranged in the cabinet body; each branch switch includes a load switch and fuses; at least two input terminals and at least two output terminals are respectively provided for the load switch and are sequentially distributed in the depth direction of the cabinet body; the fuses, the input terminals, and the output terminals are in one-to-one correspondence; fuse output ends of the fuses are electrically connected to the input terminals; at least two fuses in the branch switch are sequentially distributed in the depth direction of the cabinet body; and the depth direction of the cabinet body is perpendicular to the width direction and the height direction of the cabinet body. According to the structural layout, the depth space of the cabinet body is fully utilized.

This Application is a national stage filing under 35 U.S.C. § 371 of International Patent Application Serial No. PCT/CN2023/098538, filed Jun. 6, 2023, which claims priority to Chinese Patent Application No. 202320249612.9, titled “CABINET AND SUBSTATION FOR PHOTOVOLTAIC POWER GENERATION”, filed with the China National Intellectual Property Administration on Feb. 8, 2023. The contents of these applications are incorporated herein by reference in their entirety.

### FIELD

The present disclosure relates to the technical field of photovoltaic power generation, in particular to a cabinet and a substation for photovoltaic power generation.

### BACKGROUND

A substation for photovoltaic power generation, also referred to as a box-type substation, is usually formed by pre-assembling and integrating various devices such as a low-voltage cabinet or an inverter, a transformer, a ring main unit, and a distribution cabinet by means of an integrated platform. Branch switches are usually provided on a direct-current side of the low-voltage cabinet or the inverter in the substation so as to realize fault protection and branch breaking for the branches.

A width direction of the branch switch is consistent with a width direction of the cabinet body. Since the width of the branch switch is relatively large, the number of branch switches that can be arranged in the width direction of the cabinet body is relatively small.

In order to increase the number of branch switches and avoid increasing the width of the cabinet body, the branch switches are usually arranged in multiple layers in the height direction. The multiple branch switches need to converge. The convergence path of the multi-layer arrangement is relatively complex, which usually requires multiple-time convergence, thereby leading to an over usage of copper busbars and higher convergence cost of the branch switches.

### SUMMARY

In view of this, the present disclosure is to provide a cabinet and a substation for photovoltaic power generation, so as to increase the number of branch switches arranging in a width direction of the cabinet body.

The present disclosure provides the following technical solutions.

A cabinet includes a cabinet body and multiple branch switches provided in the cabinet body,
each of the branch switches includes a load switch and multiple fuses,
at least two input terminals and at least two output terminals are provided for the load switch and are sequentially distributed in a depth direction of the cabinet body respectively, and the multiple fuses, the at least two input terminals, and the at least two output terminals are in one-to-one correspondence, and fuse output ends of the fuses are electrically connected to the input terminals, at least two of the fuses in the branch switch are sequentially distributed in the depth direction of the cabinet body; and the depth direction of the cabinet body is perpendicular to a width direction and a height direction of the cabinet body.

A cabinet includes a cabinet body, multiple branch switches provided in an inner chamber of the cabinet body, and a heat exchanger for dissipating heat from the inner chamber of the cabinet body;
in a width direction of the cabinet body, the heat exchanger is located at one end of the cabinet body, and an output interface is provided at the other end of the cabinet body; output terminals of the branch switch converge to one end of the output member, and the other end of the output member extends to the output interface;
the cabinet body is provided with a flow-guiding air duct at one end where the output interface is located, and the output member is located in the flow-guiding air duct, which is in communication with the inner chamber of the cabinet body.

Based on the above-mentioned cabinet, the present disclosure further provides a substation for photovoltaic power generation, and the substation for photovoltaic power generation includes a cabinet, which is the cabinet described in any one of the above embodiments.

### BRIEF DESCRIPTION OF THE DRAWINGS

In order to more clearly illustrate the embodiments of the present disclosure or the technical solutions in the related technology, the accompanying drawings required in the description of the embodiments or the conventional technology will be briefly described below. Obviously, the accompanying drawings in the following description are merely some embodiments of the present disclosure, and other accompanying drawings may be obtained by those skilled in the art based on the provided accompanying drawings without any creative effort.

FIG. 1 is an isometric view of a cabinet according to an embodiment of the present disclosure;

FIG. 2 is an isometric view of a cabinet according to an embodiment of the present disclosure viewed from another direction;

FIG. 3 is a front view of a cabinet according to an embodiment of the present disclosure when a cabinet door is hidden;

FIG. 4 is an isometric view of a branch switch in the cabinet according to an embodiment of the present disclosure;

FIG. 5 is a side view of the branch switch shown in FIG. 4;

FIG. 6 is a rear view of a cabinet according to an embodiment of the present disclosure when a cabinet door is hidden;

FIG. 7 is a left view of the cabinet shown in FIG. 1;

FIG. 8 is a right side view of the cabinet shown in FIG. 1;

FIG. 9 is a top view of a substation for photovoltaic power generation according to an embodiment of the present disclosure.

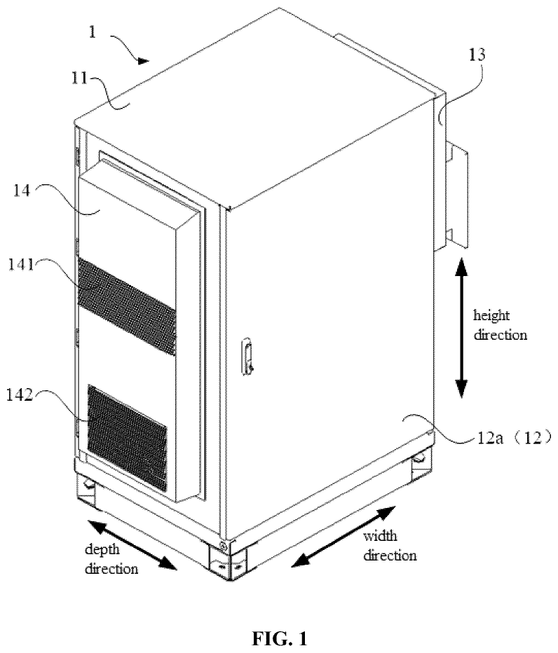

Reference numerals in FIG. 1 to FIG. 9 are explained as follows:

| | | |
|---|---|---|
| 1. cabinet; | 2. transformer; | 3. distribution cabinet; |
| 4. communication box; | 5. protective hood; | 6. low-voltage terminal; |
| 7. third conductive member; | 8. integrated platform; | |
| 11. cabinet body; | 12. cabinet door; | 12a. front cabinet door; |
| 12b. rear cabinet door; | 13. flow-guiding air duct; | 14. heat exchanger; |
| 15. branch switch; | 16. access conductive member; | |
| 17. second conductive member; | 18. converging conductive member; | |
| 19. output member; | 111. cabinet inner chamber; | 131. output interface; |
| 132. flow-guiding air inlet; | 133. flow-guiding air outlet; | 134. third fan; |
| 141. first air outlet; | 142. first air inlet; | 143. second air inlet; |
| 144. second air outlet; | 145. first fan; | 146. second fan; |
| 147. heat-exchange chamber; | 151. load switch; | 152. first conductive member; |
| 153. fuse box; | 154. fuse; | 1511. output terminal; |
| 1512. input terminal; | 1513. operating handle; | 1514. fixing part; |
| 1531. first sub-box; | 1532. second sub-box; | 1533. visual window; |
| 1534. heat-dissipation hole; | 1541. fuse output end; | 1542. fuse input end; |
| 81. first maintenance platform; | 82. second maintenance platform. | |

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are only some of the embodiments of the present disclosure, but not all the embodiments. Based on the embodiments of the present disclosure, all other embodiments obtained by those skilled in the art without creative efforts will fall within the protection scope of the present disclosure.

Reference throughout this specification to “one embodiment” or “some embodiments” or the like means that a particular feature, structure, or characteristic described in conjunction with the embodiment is included in one or more embodiments of the present disclosure. Thus, the phrases “in one embodiment”, “in some embodiments”, “in some other embodiments”, “in other embodiments” and the like appearing in different places throughout this specification do not necessarily all refer to the same embodiment, but mean “one or more but not all embodiments” unless otherwise specifically emphasized. The terms “comprising”, “including”, “having” and variations thereof mean “including, but not limited to” unless otherwise specifically emphasized.

The term “multiple or a plurality of” in the embodiment of the present disclosure refers to two or more. It should be noted that in the description of the embodiments of the present disclosure, terms such as “first” and “second” are only used for distinguishing and description, but cannot be understood as indicating or implying relative importance, nor can they be understood as indicating or implying a sequence.

The “parallel” and “perpendicular” involved in the present disclosure are “substantially parallel” and “substantially perpendicular” in actual operation. “Substantially parallel” may be understood as being parallel with a certain error. Similarly, “substantially perpendicular” may be understood as perpendicular with a certain error.

At present, a branch switch in a low-voltage cabinet usually adopts a molded case circuit breaker, and a branch switch on a direct-current side in an inverter usually adopts a molded case circuit breaker or a combination of a load switch and a fuse.

Multiple input terminals and multiple output terminals of the molded case circuit breaker are sequentially distributed in the width direction of the cabinet body respectively, resulting in a relatively large width of the molded case circuit breaker. Multiple input terminals and multiple output terminals of the load switch are sequentially distributed in the width direction of the cabinet body respectively, leading to a relatively large width of the load switch. It should be noted that “multiple” refers to two or more.

As can be seen from the above, the branch switch has a relatively large width, so that a limited number of branch switches can be arranged in a width direction of the cabinet body.

In order to arrange more branch switches, these branch switches are usually distributed in multiple layers, and these branch switches further need to converge. However, the convergence path of the multi-layer arrangement is relatively complex, which usually requires multiple-time convergence, thereby causing an over usage of copper busbars and a higher cost of convergence of the branch switches.

In addition, after the molded case circuit breaker is broken due to short-circuit, arc blasting occurs. The arc blasting is of molten charged metal particles, which can easily cause phase-to-phase or phase-to-ground short-circuit arcing, leading to a fault and poor safety and reliability.

In order to resolve the above technical problem, the present disclosure provides a cabinet. As shown in FIG. 1 to FIG. 3, the cabinet 1 according to an embodiment of the present disclosure includes a cabinet body 11 and multiple branch switches 15 provided in the cabinet body 11.

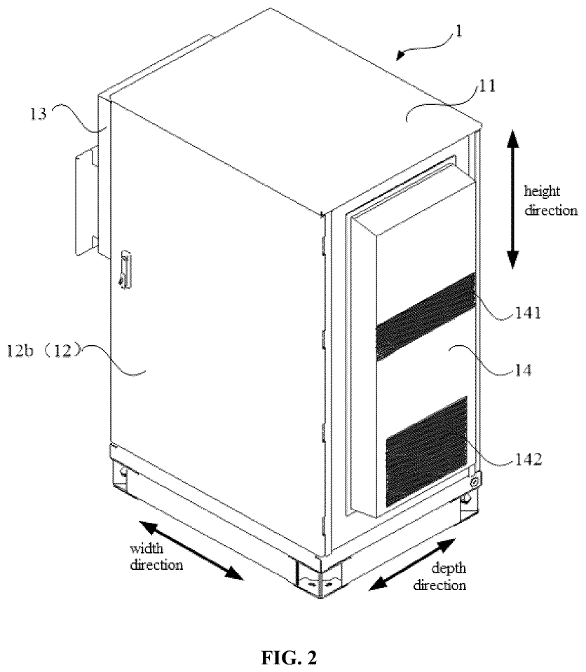

As shown in FIG. 1 and FIG. 2, the cabinet body 11 may be an outdoor cabinet, and the cabinet body 11 may have at least one cabinet door 12. Of course, the cabinet body 11 may be of other types, which is not limited to the outdoor cabinet.

At least one branch switch 15 is provided, and typically, at least two branch switches 15 are provided.

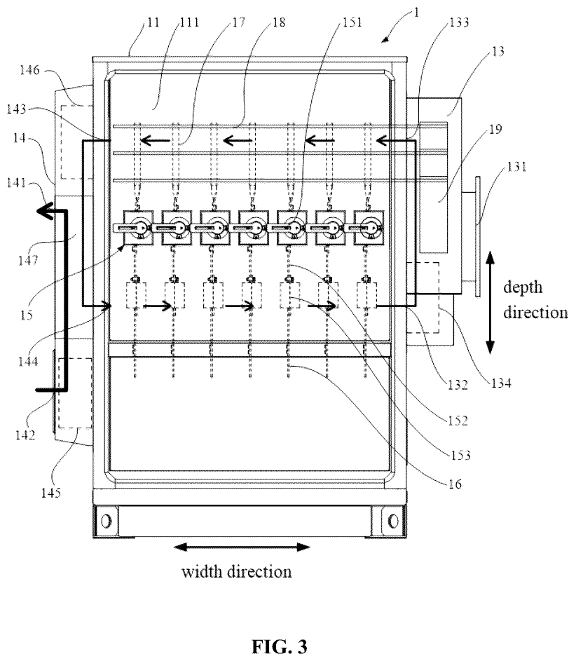

As shown in FIG. 3 and FIG. 5, each branch switch 15 includes a load switch 151 and multiple fuses 154, and each of the multiple fuse 154 is used for short-circuit protection of one branch, and the load switch 151 is used for charging and breaking of the branch.

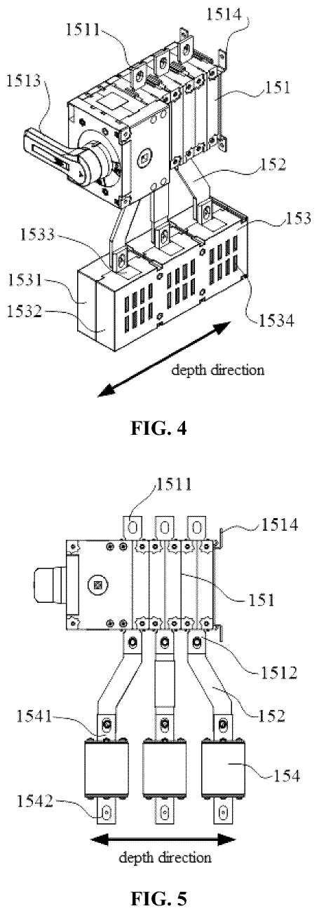

As shown in FIG. 4 and FIG. 5, fuse output ends 1541 of the fuses 154 are respectively and electrically connected to input terminals 1512 of the load switch 151; and output terminals 1511 of the load switch 151, the input terminals 1512 of the load switch 151, and the fuses 154 are in one-to-one correspondence.

To facilitate electrical connection between the fuse output ends 1541 and the input terminals 1512, the fuse output ends 1541 are respectively and electrically connected to the input terminals 1512 by means of a first conductive member 152. The first conductive member 152 may be a copper busbar or another conductive member.

In the cabinet 1 provided in the above embodiment, the branch switch 15 includes the load switch 151 and the multiple fuses 154. Compared to the case that the branch switch adopts the molded case circuit breaker, this design avoids arc blasting during short-circuit breaking of the molded case circuit breaker, reduces the occurrence of faults, and improves the safety and reliability.

The reserved space in a depth direction of the cabinet body 11 is relatively large, that is, the reserved space in a length direction of the cabinet body 11 is relatively large. Based on this, as shown in FIG. 4 and FIG. 5, at least two input terminals 1512 and at least two output terminals 1511 are respectively provided for the load switch 151 and are sequentially distributed in the depth direction of the cabinet body 11, and any two fuses 154 in the branch switch 15 are sequentially distributed in the depth direction of the cabinet body 11. It should be understood that a fuse boxes 153 is hidden in FIG. 5.

It should be noted that the depth direction of the cabinet body 11 is perpendicular to the width direction and a height direction of the cabinet body 11, the depth direction of a cabinet body 11 is perpendicular to a cabinet door 12 of the cabinet body 11, and the cabinet door 12 is parallel to the width direction and the height direction of the cabinet body 11. The term “sequentially distributed in the depth direction of the cabinet body 11” refers to that the distribution direction is consistent with the depth direction of the cabinet body 11, that is, the distribution direction is parallel to the depth direction of the cabinet body 11; or the distribution direction is relatively inclined to the depth direction of the cabinet body 11 (there is an acute angle between the distribution direction and the depth direction of the cabinet body 11). Based on this, a distribution direction of any two input terminals 1512 of the load switch 151 is either parallel to or relatively inclined to the depth direction of the cabinet body 11. Similarly, a distribution direction of any two output terminals 1511 of the load switch 151 is either parallel to or relatively inclined to the depth direction of the cabinet body 11. Additionally, a distribution direction of any two fuses 154 in the branch switch 15 is either parallel to or relatively inclined to the depth direction of the cabinet body 11.

In the cabinet 1, in order to minimize the width of the branch switch 15, the distribution direction of any two input terminals 1512 of the load switch 151 is parallel to the depth direction of the cabinet body 11; similarly, the distribution direction of any two output terminals 1511 of the load switch 151 is parallel to the depth direction of the cabinet body 11; additionally, the distribution direction of any two fuses 154 in the branch switch 15 is parallel to the depth direction of the cabinet body 11.

In the cabinet 1 provided in the above embodiment, since at least two input terminals 1512 of the load switch 151 are provided and are sequentially distributed in the depth direction of the cabinet body 11, at least two output terminals 1511 of the load switch 151 are provided and are sequentially distributed in the depth direction of the cabinet body 11, and the fuses 154 are also sequentially distributed in the depth direction of the cabinet body 11, so that the depth space of the cabinet body 11 is fully utilized, the width space of the cabinet body 11 is saved, and the number of the branch switches 15 arranged in the width direction of the cabinet body 11 can be increased. Moreover, the number of arrangement layers of the branch switches 15 can be reduced, thereby simplifying the convergence of the branch switches 15 and reducing the cost of convergence of the branch switches 15.

In some embodiments, in order to further reduce the width of the branch switch 15, the output terminals 1511 are located at a top end of the load switch 151, and the input terminals 1512 are located at a bottom end of the load switch 151. The fuse 154 is located at a bottom end of the input terminal 1512, the fuse output end 1541 is located at a top end of the fuse 154, and a fuse input end 1542 of the fuse 154 is located at a bottom end of the fuse 154.

It should be noted that the “top end” and “bottom end” in the foregoing respectively refer to “top end” and “bottom end” in a height direction of the branch switch 15, and the height direction of the branch switch 15 is a height direction of the load switch 151, which is also a height direction of the fuse 154, which is also the height direction of the cabinet body 11.

In the above embodiment, the output terminals 1511, the input terminals 1512, the fuse output ends 1541 and the fuse input ends 1542 fully utilize the height space of the cabinet body 11, so that the width space of the cabinet body 11 is saved, and the width of the branch switch 15 is significantly reduced, thereby allowing for the arrangement of more branch switches 15 in the width direction of the cabinet body 11.

In an actual situation, the output terminals 1511, the input terminals 1512, the fuse output ends 1541 and the fuse input ends 1542 may also be distributed in other ways, which is not limited to the above embodiments.

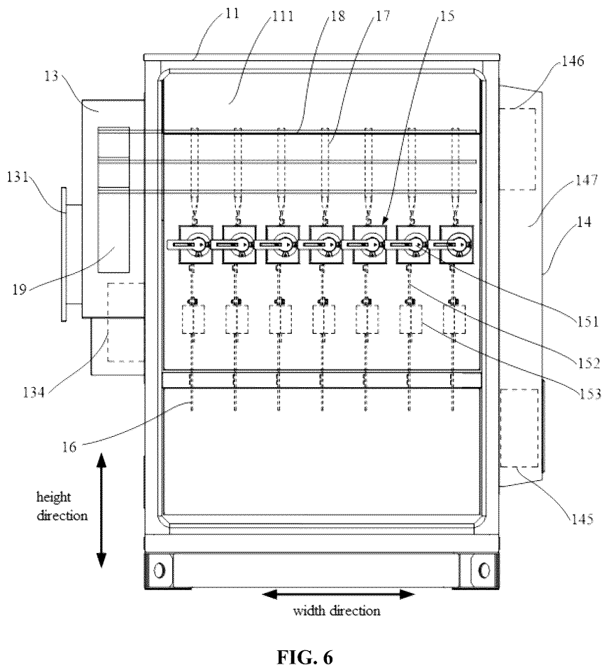

In some embodiments, as shown in FIG. 3 and FIG. 6, the cabinet 1 further includes access conductive members 16, which are in one-to-one correspondence with the fuse input ends 1542 and are electrically connected to the fuse input ends 1542. In order to reduce the width of the branch switch 15, the access conductive member 16 is located at the bottom end of the fuse 154. Of course, the access conductive member 16 can alternatively be located at other positions on the fuse 154, which is not limited to the above embodiments.

In an actual situation, the access conductive member 16 may be linear, and may extend in the height direction of the cabinet body 11.

In some embodiments, when there are two or more branch switches 15, correspondingly, there are two or more load switches 151. As shown in FIG. 3 and FIG. 6, the cabinet 1 further includes a converging conductive member 18 and an output member 19. The output terminals 1511 of any two of the load switches 151 converge to the output member 19 by means of the converging conductive member 18. In order to facilitate convergence, the output terminal 1511 is electrically connected to the converging conductive member 18 via a second conductive member 17.

The second conductive member 17 may be a copper busbar or a cable, the converging conductive member 18 may be a copper busbar or other converging member, and the output member 19 may be a copper busbar or other conductive member.

To facilitate convergence, the converging conductive member 18 is located at the top end of the load switch 151, and the output member 19 is located at one end of the cabinet body 11 in the width direction. Of course, the converging conductive member 18 may alternatively be located at other positions relative to the load switch 151, and the output member 19 is located at other positions on the cabinet body 11, which is not limited in this embodiment.

In some embodiments, the branch switches 15 are arranged in at least one layer, and at least two branch switches 15 are arranged in each layer and are sequentially distributed in the width direction of the cabinet body 11. In this case, the converging conductive member 18 may be linear, and may extend in the width direction of the cabinet body 11. As shown in FIG. 3, there are seven branch switches 15, which are sequentially distributed in the width direction of the cabinet body 11.

In some embodiments, as shown in FIG. 3 and FIG. 6, in order to arrange more branch switches 15, the branch switches 15 are arranged in two layers and are sequentially distributed in the depth direction of the cabinet body 11. Any two branch switches 15 in each layer are sequentially distributed in the width direction of the cabinet body 11, and a back side of the load switches 151 in one layer of branch switches 15 faces a back side of the load switches 151 in the other layer of branch switches 15. In this way, the convergence of the branch switches 15 is simplified, the usage of the converging conductive member 18 is reduced, and the cost of convergence of the branch switches 15 is also reduced.

It should be noted that a front side of the load switch 151 refers to the side of the load switch 151 where an operating handle 1513 is provided, and the back side of the load switch 151 is the side of the load switch 151 far away from the front side.

In order to facilitate the operation and maintenance of the branch switch 15, the front side of the load switch 151 faces the cabinet door 12 of the cabinet body 11, the load switch 151 is provided with a fixing part 1514 on the back side thereof, and the fixing part 1514 is fixed in the cabinet body 11. In order to simplify the fixation, the fixing part 1514 may be fixed in the cabinet body 11 by means of a threaded fastener.

If the branch switches 15 are arranged in two layers and sequentially distributed in the depth direction of the cabinet body 11, this arrangement is particularly suitable for the cabinet body 11 having two cabinet doors 12. The two cabinet doors 12 are a front cabinet door 12a and a rear cabinet door 12b, and the front side of one layer of load switches 151 face the front cabinet door 12a, that is, the front side of this layer of load switches 151 can be seen when the front cabinet door 12a is opened. The front side of the other layer of load switches 151 faces the rear cabinet door 12b, that is, the front side of this layer of load switches 151 can be seen when the rear cabinet door 12b is opened.

In some embodiments, as shown in FIG. 4, the cabinet 1 further includes a fuse box 153. As shown in FIG. 4 and FIG. 5, the fuse 154 is located in the fuse box 153, and the fuse output end 1541 and the fuse input end 1542 of the fuse 154 both extend out of the fuse box 153, so that the fuse 154 is mounted by the fuse box 153, which facilitates the fixing of the fuse 154 at relative position and the preassembly of the fuse 154 and the load switch 151.

In other embodiments, the fuse box 153 may not be provided.

Multiple fuse boxes 153 are provided in one-to-one correspondence with the fuses 154, or the fuse box 153 may accommodate at least two fuses 154. In order to facilitate mounting the fuse 154, the fuse boxes 153 may be in one-to-one correspondence with the fuses 154.

During operation of the cabinet 1, the fuse 154 generates heat. In order to ensure normal operation of the fuse 154, the fuse box 153 has heat-dissipation holes 1534 to facilitate heat dissipation of the fuse 154.

The distribution, shape, number and size of the heat-dissipation holes 1534 are selected according to actual needs, which is not limited in this embodiment. Of course, the fuse box 153 may realize heat dissipation of the fuse 154 through other structures, which is not limited to the heat-dissipation holes 1534.

The fuse 154 is typically provided with a fault indicator that gives an indication when the fuse 154 is blown. In order to facilitate an user to know the status of the fuse 154, the fuse box 153 is provided with a visual window 1533 that allows for checking whether the fuse 154 is blown or not. It is understood that the visual window 1533 faces the fault indicator of the fuse 154, that is to say, a person or mechanical device can check the fault indicator from the visual window 1533.

The fault indicator is typically located at the top end of the fuse 154, and the visual window 1533 is located at a top end of the fuse box 153 to facilitate checking the fault indicator.

In order to facilitate assembly of the fuse 154 and the fuse box 153, the fuse box 153 includes at least two sub-boxes, two adjacent sub-boxes are fixedly connected to each other, and any two of the sub-boxes are sequentially distributed in the width direction of the cabinet body 11.

For example, there are two sub-boxes, which are a first sub-box 1531 and a second sub-box 1532. The first sub-box 1531 and the second sub-box 1532 are sequentially distributed in the width direction of the cabinet body 11.

In an actual situation, the other number of the sub-boxes may also be provided, and any two of the sub-boxes may be distributed in other direction, which is not limited to the above description.

In the cabinet 1, each of the load switches 151 is a direct-current switch or an alternating-current switch. If each load switch 151 is a direct-current switch, then two input terminals 1512 and two output terminals 1511 are provided for each load switch 151, and each load switch 151 is connected to two fuses 154. If the load switch 151 is an alternating-current switch, then three input terminals 1512 and three output terminals 1511 are provided for each load switch 151, and each load switch 151 is connected to three fuses 154.

The cabinet 1 may be a direct-current cabinet or an alternating-current cabinet. If the cabinet 1 is a direct-current cabinet, the branch switch 15 is a direct-current switch. If the cabinet 1 is an alternating-current cabinet, the branch switch 15 is a direct-current switch and is located on a direct-current side of the alternating-current cabinet; alternatively, the branch switch 15 is an alternating-current switch.

During the operation of the cabinet 1, the branch switch 15 generates heat. In order to ensure the heat dissipation requirement of the branch switch 15, the present disclosure further provides a cabinet to improve the heat dissipation effect of the cabinet. As shown in FIG. 3 and FIG. 6, the cabinet 1 includes: a cabinet body 11, multiple branch switches 15 provided in an inner chamber of the cabinet body 11, and a heat exchanger 14 for dissipating heat from the inner chamber of the cabinet body 11, and the branch switches 15 are located in the inner chamber of the cabinet body 11. The inner chamber of the cabinet body 11 is referred to as a cabinet inner chamber 111.

The type of the heat exchanger 14 is selected according to actual needs, which is not limited in this embodiment.

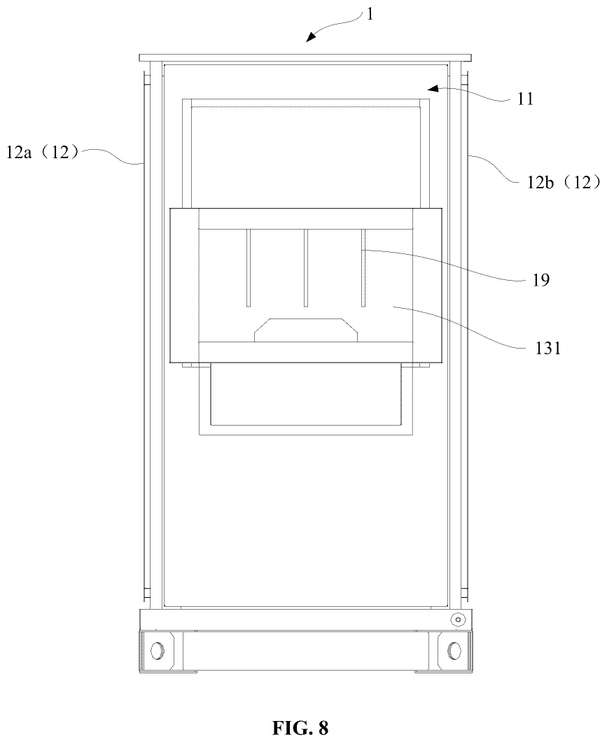

In order to improve the compactness of the cabinet 1, in the width direction of the cabinet body 11, the heat exchanger 14 is located at one end of the cabinet body 11, and an output interface 131 is provided at the other end of the cabinet body 11. The output terminals 1511 of the branch switch 15 converge to one end of the output member 19 by means of the converging conductive member 18, and the other end of the output member 19 extends to the output interface 131. It can be understood that the other end of the output member 19 is visible from the output interface 131, as shown in FIG. 8. In this way, two interfaces sequentially distributed in the width direction of the cabinet body 11 are fully utilized, so that the space utilization is improved, and the size of the cabinet 1 can be reduced.

In the above structure, the output terminals 1511 of the branch switch 15 may alternatively converge to the output member 19 in other manners, which is not limited to the converging conductive member 18.

In order to enhance the heat dissipation range and improve the heat dissipation effect, the cabinet body 11 is provided with a flow-guiding air duct 13 at one end where the output interface 131 is located. The output member 19 is located in the flow-guiding air duct 13, which is in communication with the cabinet inner chamber 111, and the branch switches 15 are located in the cabinet inner chamber 111. In this way, the flow-guiding air duct 13 is in communication with the cabinet inner chamber 111, so that the heat dissipation of the output member 19 can be realized, and the heat dissipation range is enhanced and the heat dissipation effect is improved.

It should be noted that the flow-guiding air duct 13 is located between the cabinet body 11 and the output interface 131, and the output interface 131 may be provided on the flow-guiding air duct 13. The flow-guiding air duct 13 may be integrated with the cabinet body 11, or they may be separate structures, depending on actual needs. In an actual situation, the housing of the flow-guiding air duct 13 may be a portion of the cabinet body 11, or the shell of the flow-guiding air duct 13 and the cabinet body 11 are separate components.

In order to improve the heat dissipation effect, air in the cabinet inner chamber 111 can be circulated, and the flow-guiding air duct 13 is connected in series in a circulation path of the air. Specifically, the flow-guiding air duct 13 has a flow-guiding air inlet 132 and a flow-guiding air outlet 133, which are both in communication with the cabinet inner chamber 111. In this way, the air in the cabinet inner chamber 111 enters the flow-guiding air duct 13 from the flow-guiding air inlet 132, and flows through the flow-guiding air duct 13 and then returns to the cabinet inner chamber 111 from the flow-guiding air outlet 133.

In order to improve the heat dissipation effect of the output member 19, an input end of the output member 19 faces the flow-guiding air outlet 133, and the flow-guiding air inlet 132 is located below an output end of the output member 19. It can be understood that the input end of the output member 19 refers to one end of the output member 19 connected to the converging conductive member 18, and the output end of the output member 19 refers to one end of the output member 19 far away from the converging conductive member 18.

In the above structure, the specific position of the flow-guiding air inlet 132 is selected according to actual needs, for example, the flow-guiding air inlet 132 face the fuses 154, which is not limited in this embodiment.

In an actual situation, the input end and the output end of the output member 19 may alternatively be located at other positions, which is not limited to the above structure.

In the above embodiment, in order to facilitate heat dissipation, the heat exchanger 14 may be used to cool the air in the cabinet inner chamber 111. In this case, the heat exchanger 14 may be an air-cooled heat exchanger; that is, the heat exchanger 14 cools the cabinet inner chamber 111 through heat exchange between the air outside the cabinet 1 and the air inside the cabinet inner chamber 111.

A housing of the heat exchanger 14 may be integrated with the cabinet body 11, or the housing of the heat exchanger 14 and the cabinet body 11 may be separate structures, depending on actual needs. In practice, the housing of the heat exchanger 14 may be a portion of the cabinet body 11, or the housing of the heat exchanger 14 and the cabinet body 11 may be separate components.

As shown in FIG. 3, the heat exchanger 14 includes a heat-exchange chamber 147, and the heat-exchange chamber 147 has a first air inlet 142, a first air outlet 141, a second air inlet 143 and a second air outlet 144. The first air inlet 142 and the first air outlet 141 are both in communication with an external environment of the cabinet 1, and the second air inlet 143 and the second air outlet 144 are both in communication with the cabinet inner chamber 111. In this case, the second air inlet 143, the second air outlet 144, the flow-guiding air inlet 132 and the flow-guiding air outlet 133 are sequentially distributed in the circulation path. It can be understood that a distribution direction of the second air inlet 143 and the second air outlet 144 is opposite to that of the flow-guiding air inlet 132 and the flow-guiding air outlet 133.

In order to exchange heat, the first air inlet 142 and the first air outlet 141 are located on one side of the heat-exchange chamber 147 far away from the cabinet body 11, and the second air inlet 143 and the second air outlet 144 are located on one side of the heat-exchange chamber 147 close to the cabinet body 11.

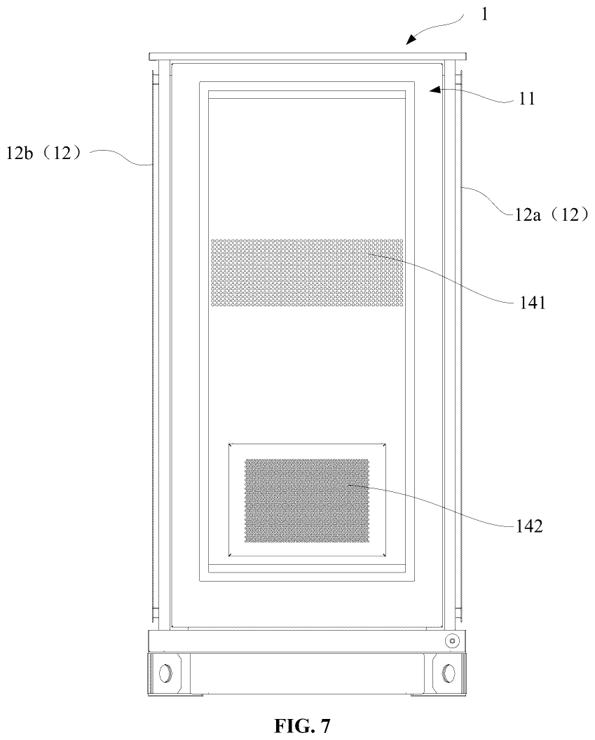

In order to improve the heat dissipation effect, the heat exchanger 14 may be a counter-flow heat exchanger, that is, a flow direction of the air flowing through the cabinet inner chamber 111 is opposite to that of the air flowing through the external environment, as shown in FIG. 3 and FIG. 7. In the height direction of the cabinet body 11, the first air inlet 142 and the first air outlet 141 are distributed from bottom to top, and the second air inlet 143 and the second air outlet 144 are distributed from top to bottom. In this case, the flow-guiding air inlet 132 and the flow-guiding air outlet 133 are distributed from bottom to top.

In order to improve the heat dissipation effect, the first air inlet 142 is located below the second air outlet 144, and the first air outlet 141 is located below the second air inlet 143.

To facilitate air flow, the heat exchanger 14 further includes at least one of a first fan 145, a second fan 146, or a third fan 134. The first fan 145 is used to drive the air outside the cabinet 1 to flow through the heat-exchange chamber 147 of the heat exchanger 14, the second fan 146 is used to drive the air inside the cabinet inner chamber 111 to flow through the heat-exchange chamber 147, and the third fan 134 is used to drive the air inside the cabinet inner chamber 111 to flow through the flow-guiding air duct 13.

It can be understood that in the heat-exchange chamber 147, the air outside the cabinet 1 is not in contact with the air inside the cabinet inner chamber 111. In this case, the heat-exchange chamber 147 has a first heat-exchange channel and a second heat-exchange channel that can perform heat exchange, wherein the second heat-exchange channel is in communication with the cabinet inner chamber 111, and the first heat-exchange channel is in communication with the external environment of the cabinet 1. That is to say, the first air inlet 142 and the first air outlet 141 are both in communication with the first heat-exchange channel, while the second air inlet 143 and the second air outlet 144 are both in communication with the second heat-exchange channel.

The first heat-exchange channel and the second heat-exchange channel can be formed according to an actual situation, which is not limited in this embodiment.

Each of the first fan 145, the second fan 146 and the third fan 134 is of a centrifugal fan, so that a wider range of circulation can be achieved, which is more beneficial to improving the heat dissipation effect. Of course, the first fan 145, the second fan 146 and the third fan 134 may alternatively be other types of fans, which is not limited in this embodiment.

As shown in FIG. 3 and FIG. 6, the first fan 145 and the second fan 146 are both provided in the heat-exchange chamber 147, and the third fan 134 is provided in the flow-guiding air duct 13 to improve the protection performance.

The first fan 145 may be provided at the first air inlet 142, the second fan 146 is provided at the second air inlet 143, and the third fan 134 is provided at the flow-guiding air inlet 132. Of course, the first fan 145, the second fan 146 and the third fan 134 may alternatively be distributed at other positions, which is not limited to the distribution shown in the figure.

The heat-exchange chamber 147 may be provided with a heat-exchange core or other heat-exchange assembly, which is not limited in this embodiment.

As shown in FIG. 3, cold air in the external environment is sucked by the first fan 145, flows through the heat-exchange chamber 147, and then is discharged through the first air outlet 141. Hot air inside the cabinet inner chamber 111 is sucked by the second fan 146 through the second air inlet 143, flows through the heat-exchange chamber 147, and then is discharged through the second air outlet 144. The cold air and the hot air are subjected to heat exchange in the heat-exchange chamber 147 to realize heat dissipation. The hot air inside the cabinet inner chamber 111 is sucked by the third fan 134 through the flow-guiding air inlet 132, flows through the flow-guiding air duct 13, and then is discharged through the flow-guiding air outlet 133 and blown to the second air inlet 143.

It should be noted that the thicker single-arrow line in FIG. 3 indicates the flow path of the cold air in the external environment, and the thinner single-arrow line indicates the flow path of the hot air inside the cabinet inner chamber 111.

In the cabinet 1, the branch switches 15 may adopt the structure and distribution shown in FIG. 3 and FIG. 6, and other structures and distributions are possible. It can be understood that the structure and distribution of the branch switches 15 are not limited by the heat-dissipation structure in the cabinet 1, and may be selected according to actual situations.

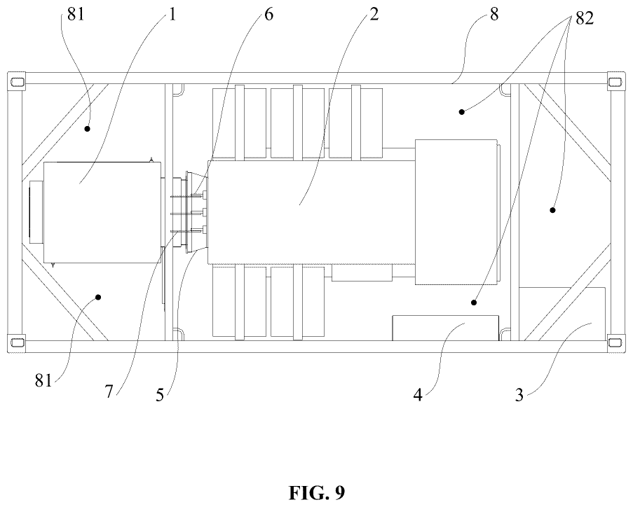

Based on the two types of cabinets 1 provided in the present disclosure, the present disclosure further provides a substation for photovoltaic power generation. As shown in FIG. 9, the substation for photovoltaic power generation includes a cabinet 1, which is the cabinet 1 described in the above embodiments.

Since the cabinet 1 provided in the above embodiments has the above technical effects, and the substation for photovoltaic power generation includes the cabinet, so the substation for photovoltaic power generation also has corresponding technical effects, which are not described in detail here.

The substation for photovoltaic power generation may be a box-type substation, as shown in FIG. 9. The substation for photovoltaic power generation includes: an integrated platform 8, a transformer 2, a power distribution cabinet 3 and a communication box 4, the latter three of which are provided on a high-voltage side of the integrated platform 8. The cabinet 1 is a low-voltage cabinet, which is provided on a low-voltage side of the integrated platform 8. The transformer 2 may be an American-type transformer or other types.

The integrated platform 8 may be a frame-type integrated platform or other types. The cabinet 1 and the transformer 2 are sequentially distributed in a length direction of the integrated platform 8, and the width direction of the cabinet 1 is the length direction of the integrated platform 8. Low-voltage terminals 6 are provided at one end of the transformer 2 close to the cabinet 1, and the low-voltage terminals 6 are electrically connected to the output member 19 of the cabinet 1 be means of a third conductive member 7, so that the converged current from the cabinet 1 is input to the transformer 2.

The third conductive member 7 extends out of the output interface 131 of the cabinet 1, and a portion of the third conductive member 7, a portion of the low-voltage terminal 6, and a junction between the third conductive member 7 and the low-voltage terminal 6 are exposed. In order to improve the protection performance, the substation for photovoltaic power generation further includes a protective hood 5. One end of the protective hood 5 is fixedly connected to the transformer 2, and the other end of the protective hood 5 is fixedly connected to the output interface 131, so that the protective hood 5 achieves protective sealing at the junction of the third conductive member 7 and the low-voltage terminal 6, thereby improving the protective performance.

The third conductive member 7 may be a flexible copper bar or other conductive members, which is not limited in this embodiment.

In the substation for photovoltaic power generation, the power distribution cabinet 3 and the communication box 4 are both located at one end of the transformer 2 far away from the cabinet 1, and they are located on a same side of the transformer 2. In this way, it is convenient for installation and maintenance.

In an actual situation, the cabinet 1, the transformer 2, the power distribution cabinet 3 and the communication box 4 may alternatively be distributed on the integrated platform 8 in other manners, which is not limited to the distribution shown in FIG. 9.

In some embodiments, in order to facilitate maintenance, a first maintenance platform 81 may be reserved on the low-voltage side of the integrated platform 8, and a second maintenance platform 82 may be reserved on the high-voltage side of the integrated platform 8.

Two first maintenance platforms 81 are distributed on two sides of the cabinet 1 in the depth direction, as shown in FIG. 9, the two first maintenance platforms 81 are distributed on the front side and the rear side of the cabinet 1. In this way, the cabinet 1 can be maintained from both sides of the cabinet 1 in the depth direction, thereby further facilitating the maintenance. Of course, alternatively, the first maintenance platform 81 is only located on one side of the cabinet 1 in the depth direction, or the first maintenance platform 81 is arranged at other positions, which is not limited in this embodiment.

The second maintenance platform 82 is located on the side of the transformer 2 far away from the cabinet 1, so that the transformer 2, the power distribution cabinet 3 and the communication box 4 are conveniently maintained. As shown in FIG. 9, multiple second maintenance platforms 82 are arranged on a front side, a rear side and a right side of the transformer 2 respectively, the power distribution cabinet 3 is located on the front side of the transformer 2, and multiple communication boxes 4 are located on the front side and the rear side of the transformer 2 respectively. Of course, the second maintenance platform 82 may alternatively be arranged at other positions, which is not limited in this embodiment.

The above description of the disclosed embodiments enables those skilled in the art to implement or utilize the present disclosure. Various modifications to these embodiments will be readily apparent to those skilled in the art, and the general principles defined herein may be implemented in other embodiments without departing from the spirit or scope of the present disclosure. Thus, the present disclosure will not be limited to the embodiments shown herein, but shall conform to a widest scope in accordance with the principle and novel features disclosed herein.

1. A cabinet, comprising: a cabinet body and a plurality of branch switches provided in the cabinet body;
wherein each of the plurality of branch switches comprises a load switch and a plurality of fuses;
at least two input terminals and at least two output terminals are provided for each load switch and are sequentially distributed in a depth direction of the cabinet body respectively; the plurality of fuses, the at least two input terminals, and the at least two output terminals are in one-to-one correspondence, and fuse output ends of the plurality of fuses are electrically connected to the at least two input terminals; at least two of the plurality of fuses in the branch switch are sequentially distributed in the depth direction of the cabinet body; and the depth direction of the cabinet body is perpendicular to a width direction and a height direction of the cabinet body.

2. The cabinet according to claim 1, wherein the at least two output terminals are located at a top end of the load switch, the at least two input terminals are located at a bottom end of the load switch, the plurality of fuses are located at bottom ends of the at least two input terminals; the fuse output ends are located at top ends of the plurality of fuses, and fuse input ends of the plurality of fuses are located at bottom ends of the plurality of fuses.

3. The cabinet according to claim 1, further comprising: a plurality of access conductive members, a converging conductive member and an output member;
wherein the plurality of access conductive members are in one-to-one correspondence with fuse input ends of the plurality of fuses and are electrically connected to the plurality of fuse input ends respectively, and the plurality of access conductive members are located at bottom ends of the plurality of fuses;
output terminals of at least two of the load switches converge to the output member by means of the converging conductive member, and the converging conductive member is located at a top end of the load switch, and the output member is located at one end of the cabinet body in the width direction.

4. The cabinet according to claim 1, wherein the plurality of branch switches are arranged in at least one layer, and at least two branch switches are arranged in each layer and are sequentially distributed in the width direction of the cabinet body.

5. The cabinet according to claim 4, wherein the plurality of branch switches are arranged in two layers and are sequentially distributed in the depth direction of the cabinet body, and a back side of the load switches in one layer of branch switches faces a back side of the load switches in the other layer of branch switches.

6. The cabinet according to claim 1, wherein a front side of the load switch faces a cabinet door of the cabinet body, the load switch is provided with a fixing part on the back side thereof, and the fixing part is fixed in the cabinet body.

7. The cabinet according to claim 1, further comprising a fuse box, the plurality of fuses are located in the fuse box, and both the fuse output ends and fuse input ends of the plurality of fuses extend out of the fuse box.

8. The cabinet according to claim 7, wherein the fuse box meets at least one of following conditions:
the fuse box has heat-dissipation holes;
the fuse box has a visual window that allows for checking whether the fuse is blown or not; or
the fuse box comprises at least two sub-boxes, two adjacent sub-boxes are fixedly connected to each other, and any two of the sub-boxes are sequentially distributed in the width direction of the cabinet body.

9. The cabinet according to claim 1, wherein the load switch is a direct-current switch or an alternating-current switch.

10. The cabinet according to claim 1, wherein the cabinet is a direct-current cabinet or an alternating-current cabinet.

11. A cabinet, comprising: a cabinet body, a plurality of branch switches provided in an inner chamber of the cabinet body, and a heat exchanger for dissipating heat from the inner chamber of the cabinet body;
wherein in a width direction of the cabinet body, the heat exchanger is located at one end of the cabinet body, and an output interface is provided at the other end of the cabinet body; output terminals of the plurality of branch switches converge to one end of an output member, and the other end of the output member extends to the output interface;
the cabinet body is provided with a flow-guiding air duct at one end where the output interface is located, and the output member is located in the flow-guiding air duct, which is in communication with the inner chamber of the cabinet body.

12. The cabinet according to claim 11, wherein air inside the inner chamber of the cabinet body is circulated, and the flow-guiding air duct is connected in series in a circulation path of the air.

13. The cabinet according to claim 11, wherein the flow-guiding air duct has a flow-guiding air inlet and a flow-guiding air outlet, which are both in communication with the inner chamber of the cabinet body; an input end of the output member faces the flow-guiding air outlet, and the flow-guiding air inlet is located below an output end of the output member.

14. The cabinet according to claim 11, wherein
the heat exchanger is an air-cooled heat exchanger;
the heat exchanger further comprises at least one of a first fan, a second fan, or a third fan;
wherein the first fan is provided for driving air outside the cabinet to flow through a heat-exchange chamber of the heat exchanger, the second fan is provided for driving air inside the inner chamber of the cabinet body to flow through the heat-exchange chamber, and the third fan is provided for driving air inside the inner chamber of the cabinet body to flow through the flow-guiding air duct.

15. A substation for photovoltaic power generation, comprising the cabinet according to claim 1.

16. The substation for photovoltaic power generation according to claim 15, further comprising: an integrated platform, a transformer, a power distribution cabinet and a communication box, wherein the transformer, the power distribution cabinet and the communication box are provided on a high-voltage side of the integrated platform;
the cabinet is provided on a low-voltage side of the integrated platform.

17. The substation for photovoltaic power generation according to claim 16, wherein the cabinet and the transformer are sequentially distributed in a length direction of the integrated platform, the power distribution cabinet and the communication box are both located at one end of the transformer far away from the cabinet and are located on a same side of the transformer; wherein the width direction of the cabinet is parallel to the length direction of the integrated platform.

18. The substation for photovoltaic power generation according to claim 16, wherein a first maintenance platform is reserved on the low-voltage side of the integrated platform, and a second maintenance platform is reserved on the high-voltage side of the integrated platform.

19. The substation for photovoltaic power generation according to claim 18, wherein two first maintenance platforms are distributed on two sides of the cabinet in the depth direction, and the second maintenance platform is located on one side of the transformer far away from the cabinet.

20. A substation for photovoltaic power generation, comprising the cabinet according to claim 11.
